(19) United States
(12) Patent Application Publication
(10) Pub. No.: US 2006/0084733 A1
(43) Pub. Date: Apr. 20, 2006

(54) Polymer composition

(76) Inventors: Douglas D. O'Brien, Bryan, OH (US); Timothy L. Walkowski, Bryan, OH (US)

Correspondence Address: HOWARD C. MISKIN;C/O STOLL, MISKIN, & BADIE, THE EMPIRE STATE BUILDING, 350 FIFTH AVENUE SUITE 4710, NEW YORK, NY, 10118, US

(21) Appl. No.: 10/968,489

(22) Filed: Oct. 19, 2004

(51) Int. Cl. C08K 5/34

(52) U.S. Cl. 524/100

(57) ABSTRACT

A polymer composition for insulating conductors comprising a polypropylene copolymer base resin blend, a flame retardant system comprising a halogen flame retardant and an antimony oxide synergist and a smoke suppressant system comprising melamine octamolybdate, zinc borate, and a silicone resin and, optionally magnesium hydroxide.

### FIELD OF THE INVENTION

The present invention relates to a polymer composition for coating conductors.

### BACKGROUND OF THE INVENTION

Plenum spaces in buildings are generally available and accessible for installing conductors, particularly conductors for power, signal, data, information, and telecommunication. Because these plenum spaces serve heating, ventilation and air conditioning functions in these building structures, special measures regarding safety are required for such conductors when installed. These measures include smoke suppressant and fire retardant characteristics.

### SUMMARY OF THE INVENTION

The polymer composition of the present invention comprises

a. a polypropylene copolymer base resin blend;

b. a flame retardant system comprising
i. a halogen flame retardant and
ii. antimony oxide; and

c. a smoke suppressant system comprising
i. melamine octamolybdate,
ii. zinc borate, and
iii. a silicone resin.

### BRIEF DESCRIPTION OF THE DRAWINGS

FIG. 1 is a front elevation, in vertical section, of a conductor with a coating of the present invention.

### DESCRIPTION OF THE PREFERRED EMBODIMENTS

The polymer composition of the present invention comprises

a. a polypropylene copolymer base resin blend;

b. a flame retardant system comprising
i. a halogen flame retardant and
ii. antimony oxide; and

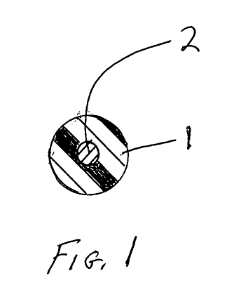

c. a smoke suppressant system comprising
i. melamine octamolybdate,
ii. zinc borate and
ii. a silicone resin.
   The polymer composition of the present invention is desirably used as an insulative coating layer 1 on a conductor 2 (FIG. 1). Such a conductor may be a conductor of electromagnetic energy, such as an electrically conductive conductor or an optical fiber for transmission of power, signal, data, information, or telecommunications. Preferably, the polymer composition of the present invention is desirably useful as an insulative coating layer on a conductor for plenum-rated wiring and cabling. The polymer composition of the present invention is a smoke suppressant, polypropylene copolymer-based polymer composition that desirably contributes to qualification under the NFPA-262 Plenum Cable test when it is used to replace at least some, if not all, of the fluorinated ethylene polymers typically used to insulate the conductors in local area network (LAN) cables. The polymer composition of the present invention incorporates novel smoke suppression technology in conjunction with halogen/antimony flame suppression chemistry.
   The Polypropylene Copolymer Base Resin Blend

The polypropylene copolymer base resin blend of the present invention comprises
a. a first polypropylene copolymer having a number average molecular weight distribution with a first average value and
b. a second polypropylene copolymer having a number average molecular weight distribution with an average value different from that of said first polypropylene copolymer,
   and preferably comprises
a. at least one polypropylene copolymer having a first molecular weight distribution and rated as “no break” for impact and having a melt flow in the 1 to 4 melt flow range and
b. at least another polypropylene copolymer having a molecular weight distribution different from said first polypropylene copolymer and rated as 1.7 to 3.3 for impact and having a higher melt flow in the 4 to 12 melt flow range,

said polypropylene copolymer base resin blend preferably having the following properties:

TABLE I

| | Broad Range | | Desired Range | | Preferred Range | |
|---|---|---|---|---|---|---|
| | From | To | From | To | From | To |
| Property | About | About | About | About | About | About |
| Melt Flow | 0.5 | 20 | 2 | 12 | 4 | 8 |
| Rate¹ | | | | | | |
| Density² | .89 | .91 | .89 | .91 | .900 | .904 |
| Izod Impact | 1.0 | No | 1.7 | No break | 3.3 | No |
| Strength³ | | break | | | | break |

¹As determined per ASTM D-1238 at 230° C./2.16 kg. Values are expressed in grams per 10 minutes
²As determined per ASTM D-792. Values are expressed in grams per cubic centimeter.
³As determined per ASTM D-256 using method A at 23° C. and with notched test specimen. Values are expressed as “no break” if the test specimen does not break and, if otherwise, in foot-pound per inch.

A polymer with a broad or even bi-modal number average molecular weight distribution is desirable in extrusion coating because such a polymer is more shear sensitive and thins out at high shear rates providing a smooth, uniform surface. (The ratio of the weight-average molecular weight to the number-average molecular weight gives an indication of the molecular weight distribution.) Unfortunately, most polypropylenes (homopolymers and copolymers) today are manufactured using “controlled rheology” (CR) or “viscosity-broken” (VB) technologies that result in a narrower number average molecular weight distribution. A narrower number molecular weight distribution reduces the shear sensitivity, especially at high shear rates such as are commonly encountered in small diameter dies used for wire coating category 5 LAN cables, and the result is an undesirable surface. It is therefore necessary, with polypropylene (homopolymers and copolymers), to introduce at least one additional polymer having a number average molecular weight distribution with a different average value from the first polypropylene to provide the broadening or bi-modal number average molecular weight distribution in order to provide these desirable characteristics.

Polypropylene and other linear polymers display a flow phenomenon known as oscillatory flow. Oscillatory flow can disrupt the proper centering of the conductor within the polymer coating, such as the metallic conductor, and lead to degraded electrical properties of the insulated conductor. Oscillatory flow will be most evident on small diameter constructions particularly at high coating speeds. Category 5 and category 6 local area network cables are among the more common cables using small diameter insulated conductors today and it desirable to provide these conductors with insulative coatings at high speeds. However, heretofore, oscillatory flow has limited typical wire & cable polypropylenes to line speeds under 3,000 lineal feet of insulated conductor per minute. The effect of using the polypropylene copolymer base resin blend-based polymer composition of the present invention is to increase the line speed at which the melt flow still remains stable, i.e., does not exhibit oscillatory flow. Line speeds in excess of 6,500 feet per minute have been demonstrated with the polypropylene copolymer base resin blend-based polymer composition of the present invention.

The polypropylene copolymer base resin blend is a copolymer of propylene and at least one other α-olefin comonomer such as ethylene, butylene, pentene or octene. Ethylene is the preferred comonomer. The polypropylene copolymer base resin blend may be comprised of random or block copolymers.

The term “polypropylene copolymer” is intended to include copolymers, terpolymers, and other polymers of greater than two comonomers. The term “polypropylene copolymer” is also intended to include mixtures, blends, and alloys of polypropylene copolymers and mixtures, blends, and alloys of polypropylene copolymers with other polymers. Suitable polypropylene copolymer base resins for polypropylene copolymer base resin blends are:

1. impact poly(propylene-ethylene) copolymers rated as “no-break” in the notched Izod impact test ASTM D-256 (method A), such as the impact copolymers available commercially from Exxon Mobil as PP7032 KN, PP7032 E2, PP8023, and PP8074 or similar resins from other manufacturers. The term “impact copolymer” is a commonly used term meaning a polypropylene copolymer with some level of resistance to impact, such resistance being quantified by receiving a “impact resistance value” in the ASTM D 256 test, “Standard Test Methods for Determining the Izod Pendulum Impact Resistance of Plastics.” These are typically and preferably random or block propylene/ethylene copolymers.

2. impact poly(propylene-ethylene) copolymers rated as greater than 1.1 ft-lb/in in the notched Izod impact test ASTM D-256 (method A), such as the impact copolymers available commercially from Exxon Mobil as PP7033 E2, PP7033 N, PP9122, or the impact copolymers available commercially from Fina as PP4520, PP4320.

Flame Retardant System

The flame retardant system comprises a halogenated flame retardant and antimony oxide. Alternative materials are zinc stannate, dicumene and others.

Halogenated Flame Retardant Component

Suitable halogenated flame retardants are chlorinated and/or brominated flame retardants commonly used in plastics. Preferred chlorinated flame retardants are:
1. (1,2,3,4,7,8,9,10,13,13,14,14-dodecachloro-1,4,4a,5,6,6a,7,10,10a,11,12,12a-dodecahydro-1,4,7,10-dimethanodibenzo(a,e)cyclooctene) available commercially from Laurel Industries as Dechlorane Plus, Dechlorane +25 and Dechlorane +35;
2. Chlorinated olefin waxes, such as those available commercially from Dover Chemical as Chlorez 760 or Chlorez 700S; and
3. Chlorinated polyethylene resins such as those available commercially from DuPont Dow Elastomers as Tyrin 674
   or the like.

Alternative halogenated materials are brominated materials, such as brominated epoxy oligomers available commercially from DSBG Inc. as F-3014. Also a suitable alternate is tris(tribromophenoxy) triazine available commercially from DSBG Inc. as FR-245. Also, the carbonate oligomers of tetrabromobisphenol-A may be used, such as those available commercially from Great Lakes Chemical as BC-52HP and BC-58.

While brominated flame retardants are also candidate halogen flame retardant components, the smoke levels are usually higher with such brominated additives, and it is advisable to blend such brominated flame retardant additives with a chlorinated flame retardant additive to minimize the smoke increase.

Antimony Oxide Synergist Component

Suitable antimony oxide synergists are available commercially from Laurel Industries as Fireshield H; from Great Lakes Chemical as Antimony Oxide TMS; and from Polymer Additives Group as Charmax FR-AO. The antimony oxide synergist should be present at a ratio of 2 or 3 halogen to 1 antimony on a weight ratio, e.g., a weight ratio of 2 to 3 parts by weight of the halogen additive to 1 part by weight of antimony oxide.

Additional Synergist Component

Additional synergist component materials may be used, such as dicumene, zinc stannate, and blends of antimony oxide (Sb₂O₃) with other metal oxides, such as Charmax FR-Z8s or FR-20S or FR-30S from Polymer Additives Group.

Smoke Suppressant System

The smoke suppressant system comprises melamine octamolybdate, zinc borate, a silicone resin and, optionally and additionally, magnesium hydroxide.

Melamine Octamolybdate

Suitable melamine octamolybdate is available commercially as Uniplex M8M from Unitex Chemical Corp. Melamine octamolybdate combines the smoke-reducing power of molybdenum with the char-forming capability of melamine in the same molecule. This material is also white in color as opposed to the dark gray to steel gray color of other molybdenum products. Thus, low smoke compounds made with melamine octamolybdate are more easily colored satisfying a critical requirement for wire and cable insulations for color-identification indicia on the wire and cable.

Zinc Borate

Suitable zinc borates are available commercially from U.S. Borax Inc as Firebreak ZB, Firebreak ZB-XF, and from Polymer Additives Group as Charmax 400 and Charmax 400 lite. Alternative materials are the anhydrous zinc borates available commercially from Borax Inc as Firebrake FR-415 or Firebrake-500 and zinc oxide in combination with a metal borate, such as zinc oxide in combination with magnesium metaborate or calcium metaborate available commercially from Polymer Additives Group as Charmax FR.

Silicone Resin

The silicone resin works differently than the optional additional magnesium hydroxide. The silicon (Si) forms a glassy reflective surface layer and retards the formation of volatile fractions of the polymer thus slowing the combustion rate. Magnesium hydroxide functions to cool and dilute the flame front and to tie up some carbon (carbon burns hot if it gets into the gas phase) on the surface. Suitable silicone resins are commercially available from Dow Corning as 4-7081.

Magnesium Hydroxide

Suitable magnesium hydroxides are available commercially from Polymer Additives Group as Hydramax HM-C9SA; from Albemarel as Magnifin H-10A; and from Huber Engineered Materials as Zerogen and Vetrtx. Various particle sizes and surface treatments are available among the various grades.

The magnesium hydroxide may be used with surface treatment or without surface treatment. Alternatively, magnesium oxide at various level of hydration may be used.

Stabilizer System

Preferably, the composition additionally includes a stabilizer system comprising a stabilizer with respect to copper, such as Irganox MD1024 from Ciba Specialty Chemicals and one or more phenolic antioxidant additives (with or without a hindered amine or both.) Suitable phenolic antioxidant stabilizers are available commercially from Ciba Specialty Chemicals Corp as IRGANOX 1010, and CHEMISORB 944. Alternative phenolic antioxidant stabilizers are suitable phenolic antioxidants for polyethylene or polypropylene, such as IRGAFOS 168 available commercially from Ciba Specialty Chemicals Corp, and DSTP-type amines or other hindered amines.

Impact Modifier

Preferably, the composition also additionally comprises an impact modifier. An impact modifier provides desired physical properties, tensile strength, and ultimate strength to the composition of the present as placed on the conductor. Suitable impact modifiers are ethylene-propylene-diene monomer polymers (EPDM) or very low density polyethylene resins (VLDPE), such as EXACT from Exxon Mobil, ENGAGE from DuPont Dow Elastomers or FLEXOMER from Dow Chemical, with a melt flow rate (or “melt index”) of about 2.0 to about 12.0 (190° C./216 Hg) and a density of about 0.850 to about 0.910 g/cm.^{3.} Polar copolymers, such as ethylene methyl acrylate (EMA), ethylene butyl acrylate (EBA) and ethylene vinyl acetate (EVA) may also be used as impact modifiers and are available commercially from Exxon Mobil as OPTEMA, ENABLE, and ESCORENE, respectively. (Ethylene ethyl acrylate (EEA) available from E.I. duPont may also be used as impact modifiers.

Table II describes a preferred composition and desired and broad ranges of compositions in accordance with the present invention.

TABLE II

| | Preferred | Desired | Broad |
|---|---|---|---|
| | Range | Range | Range |
| Material | (Wt %) | (Wt %) | (Wt %) |
| Polypropylene Copolymer Base Resin | 48-49.69 | Balance | 35-65 |
| Blend | | | |

Flame Retardant System

| | | | |
|---|---|---|---|
| Halogen Flame Retardant | 7.60-7.80 | 7-10 | 1-20 |
| Antimony Oxide Synergist | 2.42-2.63 | 0.1-3.3 | 5-10 |

Smoke Suppressant System

| | | | |
|---|---|---|---|
| Zinc Borate | 13.5-15.2 | 13-16 | 5-25 |
| Melamine octamolybdate | 2.9-4.6 | 2.5-4.5 | 1-6 |
| Magnesium Hydroxide | 7.6-13.5 | 7-14 | 0-50 |
| Silicone resin | 5.0-5.12 | 4-6 | 2-8 |

Table III describes a preferred composition and desired and broad ranges of compositions in accordance with the present invention including a stabilizer system.

TABLE III

| | Preferred | Desired | Broad |
|---|---|---|---|
| | Range | Range | Range |
| Material | (Wt %) | (Wt %) | (Wt %) |
| Polypropylene Copolymer Base Resin | 48-49.69 | Balance | 35-65 |
| Blend | | | |

Flame Retardant System

| | | | |
|---|---|---|---|
| Halogen Flame Retardant | 7.60-7.80 | 7-10 | 1-20 |
| Antimony Oxide Synergist | 2.42-2.63 | 0.1-3.3 | 5-10 |

Smoke Suppressant System

| | | | |
|---|---|---|---|
| Zinc Borate | 13.5-15.2 | 13-16 | 5-25 |
| Melamine octamolybdate | 2.9-4.6 | 2.5-4.5 | 1-6 |
| Magnesium Hydroxide | 7.6-13.5 | 7-14 | 0-50 |
| Silicone resin | 5.0-5.12 | 4-6 | 2-8 |

Stabilizer System (optional)
Phenolic antioxidant additives

| | | | |
|---|---|---|---|
| [Irganox 1010] | 0.15-0.292 | 0.1-0.2 | 0-0.4 |
| [Irganox 1024] | 0.15-0.175 | 0.1-0.2 | 0-0.4 |
| [Chemisorb 944] | 0 | 0-0.2 | 0-0.4 |

Table IV describes a preferred composition and desired and broad ranges of compositions in accordance with the present invention including an impact modifier.

TABLE IV

| | Preferred | Desired | Broad |
|---|---|---|---|
| | Range | Range | Range |
| Material | (Wt %) | (Wt %) | (Wt %) |
| Polypropylene Copolymer Base Resin | 48-49.69 | Balance | 35-65 |
| Blend | | | |

Flame Retardant System

| | | | |
|---|---|---|---|
| Halogen Flame Retardant | 7.60-7.80 | 7-10 | 1-20 |
| Antimony Oxide Synergist | 2.42-2.63 | 0.1-3.3 | 5-10 |

Smoke Suppressant System

| | | | |
|---|---|---|---|
| Zinc Borate | 13.5-15.2 | 13-16 | 5-25 |
| Melamine octamolybdate | 2.9-4.6 | 2.5-4.5 | 1-6 |
| Magnesium Hydroxide | 7.6-13.5 | 7-14 | 0-50 |
| Silicone resin | 5.0-5.12 | 4-6 | 0-8 |
| Impact Modifier (optional) | 9.2-9.6 | 8.5-10.3 | 0-11 |

Table V describes a preferred composition and desired and broad ranges of compositions in accordance with the present invention including a stabilizer system and an impact modifier.

TABLE II

| | Preferred | Desired | Broad |
|---|---|---|---|
| | Range | Range | Range |
| Material | (Wt %) | (Wt %) | (Wt %) |
| Polypropylene Copolymer Base Resin | 48-49.69 | Balance | 35-65 |
| Blend | | | |

Flame Retardant System

| | | | |
|---|---|---|---|
| Halogen Flame Retardant | 7.60-7.80 | 7-10 | 1-20 |
| Antimony Oxide Synergist | 2.42-2.63 | 0.1-3.3 | 5-10 |

Smoke Suppressant System

| | | | |
|---|---|---|---|
| Zinc Borate | 13.5-15.2 | 13-16 | 5-25 |
| Melamine octamolybdate | 2.9-4.6 | 2.5-4.5 | 1-6 |
| Magnesium Hydroxide | 7.6-13.5 | 7-14 | 0-50 |
| Silicone resin | 5.0-5.12 | 4-6 | 0-8 |

Stabilizer System (optional)
Phenolic antioxidant additives

| | | | |
|---|---|---|---|
| [Irganox 1010] | 0.15-0.292 | 0.1-0.2 | 0-0.4 |
| [Irganox 1024] | 0.15-0.175 | 0.1-0.2 | 0-0.4 |
| [Chemisorb 944] | 0 | 0.1-0.2 | 0-0.4 |
| Impact Modifier (optional) | 9.2-9.6 | 8.5-10.3 | 0-11 |

### EXAMPLES

Examples of compositions in accordance with the present invention are set forth in Examples 1 through 3.

### Example 1

A composition of the present invention comprised as follows is prepared:

| Material | Wt % |
|---|---|
| Base Resin Blend (Exxon PP 7032 & 7033) | Balance |
| Impact Modifier (Exact 0210) | 8.2 |
| Halogen Flame Retardant Materials | |
| Halogen Flame Retardant (Dechlorane +35) | 13.8 |
| Antimony Oxide Synergist (Antimony Oxide TMS) | 13.8 |
| Smoke Suppressant material | |
| Zinc Borate (Firebreak ZB-XF) | 2.75 |
| Melamine OctaMolybdate (Uniplex M8M) | 2.75 |
| Magnesium Hydroxide (Magnifin H-10A) | 5.6 |
| Silicone resin (Dow Corning 4-7081) | 4.6 |
| Stabilizer System | |
| Phenolic antioxidant additives: | |
| Irganox 1010 | 0.17 |
| Irganox 1024 | 0.27 |

The polymer composition is prepared as follows:

a. The powders (Dechlorane +35, Antimony Oxide TMS, Firebreak ZB-XF, Uniplex M8M, Magnifin H-10A), Dow Corning 4-7081, Irganox 1010, Irganox 1024, and Chemisorb 944) are preblended in a ribbon blender, such as those manufactured by Marion Mixers in various sizes.

b. Then, the resins (Exxon PP 7032, Exxon PP 7033 and Exact 0210) and the preblended powders are melt-compounded in a continuous mixer (Model CP-500 manufactured by Farrel Inc.)

c. Then the melt-compounded resins and preblended powders, as melt-compounded, are melt pelletized in an underwater pelletizer (Model 6 manufactured by Gala Industries.) The polymer composition exhibits the following properties:

| Property | Value |
|---|---|
| Tensile Strength | 1,600 psi |
| Elongation | 350% |
| Peak smoke value** | 2.45 |
| Average smoke value** | 1.36 |

**Using a 2 foot smoke tunnel attached to a Cone Calorimeter.

### Example 2

The following composition is prepared:

| | Amount |
|---|---|
| Material | (Wt %) |
| Base Resin Blend of Exxon PP 7032 & 7033 | Balance |
| Impact Modifier Exact 0210 | 9.4 |
| Halogen Flame Retardant Materials | |
| Halogen Flame Retardant Dechlorane +35 | 7.60 |
| Antimony Oxide Synergist Antimony Oxide TMS | 2.6 |
| Smoke Suppressant material | |
| Zinc Borate Firebreak ZB-XF | 15.2 |
| Melamine OctaMolybdate Uniplex M8M | 2.9 |
| Magnesium Hydroxide Magnifin H-10A | 7.6 |
| Silicone resin Dow Corning 4-7081 | 5.1 |
| Stabilizer System | |
| Phenolic antioxidant additives | |
| Irganox 1010 | 0.17 |
| Irganox 1024 | 0.29 |

using the preparation method set forth in Example 1.

The polymer composition exhibits the following properties:

| Property | Value |
|---|---|
| Tensile Strength | 1,700 psi |
| Elongation | 550% |
| Peak smoke value** | 1.75 |
| Average smoke value** | 0.89 |

**Using a 2 foot smoke tunnel attached to a Cone Calorimeter.

### Example 3

The following composition is prepared:

| | Amount |
|---|---|
| Material | (Wt %) |
| Base Resin Blend of Exxon PP 7032 & 7033 | Balance |
| Impact Modifier Exact 0210 | 10.4 |
| Halogen Flame Retardant Materials | |
| Halogen Flame Retardant Dechlorane +35 | 07.5 |
| Antimony Oxide Synergist Antimony Oxide TMS | 0.3 |
| Smoke Suppressant material | |
| Zinc Borate Firebreak ZB-XF | 22.6 |
| Melamine OctaMolybdate Uniplex M8M | 5.3 |
| Magnesium Hydroxide Magnifin H-10A | 0.6 |
| Silicone resin Dow Corning 4-7081 | 4.8 |
| Stabilizer System | |
| Phenolic antioxidant additives | |
| Irganox 1010 | 0.17 |
| Irganox 1024 | 0.29 |

using the preparation method set forth in Example 1.

The polymer composition exhibits the following properties:

| Property | Value |
|---|---|
| Tensile Strength | 1,700 psi |
| Elongation | 450% |
| Peak smoke value** | 1.71 |
| Average smoke value** | 0.662 |

**Using a 2 foot smoke tunnel attached to a Cone Calorimeter.

The foregoing description is for purposes of illustration only and is not intended to limit the score of protection accorded the invention. While the present invention has been described and illustrated by reference to various specific exemplary materials, procedures, examples and embodiments, it should be understood that the present invention should not be restricted to the specific exemplary materials, procedures, examples and embodiments selected for description and illustration and that other materials, procedures, examples and embodiments, as well as various additions and omissions, can be used that do not depart from the spirit and scope of the present invention, as will be appreciated by those skilled in the art given the benefit of this disclosure. The scope of protection is to be measured by the following claims, which should be interpreted to give the broadest protection that the invention permits.

1. A polymer composition comprising
a. a polypropylene copolymer base resin blend;
b. a flame retardant system comprising
i. a halogen flame retardant and
ii. antimony oxide; and
c. a smoke suppressant system comprising
i. melamine octamolybdate,
ii. zinc borate, and
iii. a silicone resin.

2. A polymer composition as recited in claim 1, wherein said polypropylene copolymer base resin blend comprises
a. a first polypropylene copolymer having a number average molecular weight distribution with a first average value and
b. a second polypropylene copolymer having a number average molecular weight distribution with an average value different from that of said first polypropylene copolymer.

3. A polymer composition as recited in claim 1, wherein said polypropylene copolymer base resin blend comprises
i. a first polypropylene copolymer rated as “no break” for impact and having a melt flow in the 1 to 4 melt flow range and
ii. a second polypropylene copolymer rated as 1.7 to 3.3 for impact and having higher melt flow in the 4 to 12 melt flow range.

4. A polymer composition as recited in claim 1, wherein said polymer composition further comprises an impact modifier.

5. A polymer composition as recited in claim 1, wherein said composition comprises a stabilizer system.

6. A polymer composition as recited in claim 1, wherein said smoke suppressant system further comprises magnesium hydroxide.

7. A polymer composition as recited in claim 1, wherein said smoke suppressant system further comprises anhydrous zinc borate.

8. A polymer composition as recited in claim 1, wherein said composition comprises a functional olefin copolymer or terpolymer.

9. A polymer composition as recited in claim 1, wherein said composition comprises a functional olefin copolymer or terpolymer in a blend of HDPE and LLDPE.

10. A conductor having a coating comprising a polymer composition comprising
a. a polypropylene copolymer base resin blend;
b. a flame retardant system comprising
i. a halogen flame retardant and
ii. antimony oxide; and
c. a smoke suppressant system comprising
i. melamine octamolybdate,
ii. zinc borate, and
iii. a silicone resin.

11. A conductor as recited in claim 10, wherein said polypropylene copolymer base resin blend comprises
a. a first polypropylene copolymer having a number average molecular weight distribution with a first average value and
b. a second polypropylene copolymer having a number average molecular weight distribution with an average value different from that of said first polypropylene copolymer

12. A conductor as recited in claim 10, wherein said polypropylene copolymer base resin blend comprises
i. a first polypropylene copolymer rated as “no break” for impact and having a melt flow in the 1 to 4 melt flow range and
ii. a second polypropylene copolymer rated as 1.7 to 3.3 for impact and having higher melt flow in the 4 to 12 melt flow range.

13. A conductor as recited in claim 10, wherein said polymer composition further comprises an impact modifier.

14. A conductor as recited in claim 10, wherein said composition comprises a stabilizer system.

15. A conductor as recited in claim 10, wherein said smoke suppressant system further comprises magnesium hydroxide.

16. A conductor as recited in claim 10, wherein said smoke suppressant system further comprises anhydrous zinc borate.

17. A conductor as recited in claim 10, wherein said composition comprises a functional olefin copolymer or terpolymer.

18. A conductor as recited in claim 10, wherein said composition comprises a functional olefin copolymer or terpolymer in a blend of HDPE and LLDPE.

19. A polymer composition comprising
a. a polypropylene copolymer base resin blend comprising
i. a first polypropylene copolymer having a number average molecular weight distribution with a first average value and
ii. a second polypropylene copolymer having a number average molecular weight distribution with an average value different from that of said first polypropylene copolymer;
b. a flame retardant system comprising
i. a halogen flame retardant and
ii. antimony oxide; and
c. a smoke suppressant system comprising
i. melamine octamolybdate,
ii. zinc borate, and
iii. a silicone resin.
